(19) United States
(12) Patent Application Publication
(10) Pub. No.: US 2026/0221923 A1
(43) Pub. Date: Jul. 30, 2026

(54) AC-SIDE ACTIVE COMMON-MODE FILTER FOR INVERTERS

(71) Applicant: Webasto SE, Stockdorf (DE)

(72) Inventor: Rudolf Haeussermann, Stockdorf (DE)

(21) Appl. No.: 19/147,485

(22) PCT Filed: Dec. 5, 2023
(86) PCT No.: PCT/EP2023/084329

§ 371 Date: Jul. 11, 2025

(30) Foreign Application Priority Data
Jan. 13, 2023 (DE) 10 2023 200 273.6

(51) Int. Cl. H02P 27/08; G05F 1/12; H02P 29/50

(52) U.S. Cl. CPC H02P 27/08; G05F 1/12; H02P 29/50

(57) ABSTRACT

A control device for operating a load by means of pulse-width-modulated voltage signals via a wiring harness comprising two or more drive lines comprises: a signal generator for respectively generating and feeding the pulse-width-modulated voltage signals into a corresponding one of the drive lines, a transformer having a respective winding for each of the drive lines and having a compensation winding, and a controller circuit designed to control a voltage applied to the compensation winding in order to reduce a possible common-mode voltage on the drive lines.

### CROSS-REFERENCE TO RELATED APPLICATIONS

This application is a 35 U.S.C. § 371 National Stage Entry of International Application No. PCT/EP2023/084329 filed Dec. 5, 2023, which claims the priority benefit of German Patent Application Serial Number DE 10 2023 200 273.6 filed Jan. 13, 2023, all of which are incorporated herein by reference in their entirety for all purposes.

### TECHNICAL FIELD

Various aspects relate to a control device for operating a load, in particular a brush-operated or brushless DC motor, in particular a motor for driving movable components in a motor vehicle, such as a sunroof or a vehicle window.

### BACKGROUND

It is known and also common practice to often operate DC motors, in particular for sunroofs or window lifters, with pulse-width-modulated voltage signals (hereinafter also PWM signals for short) for regulating the speed. Brushless (brushless direct current, BLDC) motors even require control via PWM signals due to electronic commutation. In addition, other electronic components such as solenoid switches, solenoid valves and relays are often also driven via PWM signals. In addition, the regulation of heating or lighting elements as well as the driving of switchable films (e.g. PLDC) can also be the subject of control via PWM signals. Motors, relays, valves, heating or lighting elements, etc. are subsumed below under the term “load”.

In many applications—the above-mentioned use of DC motors in vehicles may be cited as a typical example—the respective load and a control device that effects the control via PWM signals are spatially separate from each other. The respective drive lines are regularly combined in a cable harness (consisting of at least two drive lines: supply and return lines). The PWM signals are routed via these lines, and so the PWM signals may often be injected into other existing electronic devices in the environment, for example into the vehicle antenna in the case of vehicles.

In the latter case, radio reception, particularly of the medium wave, can be affected or at least noticeably disturbed.

On the drive lines, the current flowing to the load and the current flowing back from the load ideally cancel each other out, and so there is no interference (push-pull). Nevertheless, capacitive coupling, stray capacitances, etc. can also occur, and so the drive or useful signals do not cancel each other out and therefore synchronous or unidirectional control signals with the same amplitude and phase angle are transmitted and thus lead to interference.

However, in contrast, the common mode voltage is a comparatively larger problem in the present case. It would be desirable to have a profile in which the two drive lines are at the same voltage level U/2 in a first state of the PWM signal, while, in the second switching state, one drive line is at the supply voltage U (for the load), and the other is at 0 V. Similarly, this signal transmission takes place during data transmission, e.g. USB, CAN, etc. If, however, powers of a relevant magnitude need to be switched, as in the present case, then the generation of such a signal (taking into account the symmetry in particular) is not practical. Therefore, one drive line is usually connected to ground (0 V), while the other drive line is connected by the corresponding bridge and voltage levels of between 0 V and U are therefore applied thereto. The common mode voltage corresponds in this case to the time average of half the PWM signal voltage. It is clear that the interference caused by this can be considerable.

In order to counteract such interference based on electromagnetic interference (EMI), various measures for reducing it are known. In the simplest case, the cable harnesses or parts thereof can be electromagnetically shielded using a suitable sheath. The disadvantage here is that the shielding as well as the often non-existent ground connection cause additional costs. Alternatively or additionally, the PWM frequency can also be synchronized with the radio transmitter, but this interferes with the design and degree of freedom when selecting the electronic components.

In addition, push-pull operation is also possible, but this is already complicated for 2 signals, and is hardly possible for 3 signals as with BLDC motors.

The document DE 10 2016 205 338 A1 describes a control device in which a push-pull signal that is not otherwise used is generated by a mirror circuit and is carried along in the cable harness via a so-called compensation line in order to simulate push-pull operation. However, the corresponding compensation line is insulated in relation to the load.

However, a disadvantage of this solution is that an additional cable in the cable harness and an additional contact on the corresponding connector are required. In addition, the connector assignment or the cable harness is already defined by a third party, and so any changes in this respect will involve a disproportionate amount of effort. In addition, in order to compensate for the common mode component, a signal level is required that corresponds to twice the interference signal for a conventional DC motor or to three times the interference signal for a BLDC motor (multiplier: number of lines), with the result that the technical limits are reached quickly in terms of the supply voltage of the amplifiers, the provision of rail-to-rail operational amplifiers and the handling of comparatively high slew rates, etc., resulting in additional costs. Furthermore, the interfering drive lines and the compensation line are not exposed to the same impedance at their end. Especially at higher frequencies, this can result in the compensation signal at the load-side end of the lines not corresponding to the inverted interference signal, and thus the mutual cancellation not turning out as desired. Finally, only the lines in the cable harness are compensated, but not the emission of the control device itself, which can also itself contribute to the interference, depending on the position with respect to the antenna.

The document U.S. Pat. No. 5,936,856 A proposes, in connection with the control of an asynchronous motor, a control device in which a compensation transformer is set up on the drive lines.

One winding is wound onto this transformer for each drive line. The current flowing to the load and the current flowing back from the load cancel each other out in the transformer, and so the latter is not “visible” to the pure useful signal in the push-pull mode, i.e., shows no effects. For the common mode component, a common mode capture circuit and a comparator circuit are set up and control a multi-level half-bridge inverter depending on the captured common mode signal, such that the inverter outputs a compensation signal for a compensation winding in the transformer. This is intended to be used to compensate for the common mode interference. A structurally similar control device is proposed in the document CN112564587 A.

As a result, the interference signal on the drive lines between a corresponding signal generator and the transformer is thus measured directly in this proposal and then subtracted from the useful signal via the transformer. However, the disadvantage is that here there is only simple, merely “predictive” control, and the interference signal is therefore possibly not fully compensated due to asymmetries or non-linearities, etc. In addition, any resonances with the load capacitance may not be adequately taken into account.

Furthermore, there is a serious disadvantage here in that the dimensioning of the transformer used in each case depends directly on the integral of the applied voltage, that is to say on the temporal integral of the interference or common mode signal to be compensated in the setup according to U.S. Pat. No. 5,936,856 A. The problem actually does not arise for the proposed use in asynchronous motors, but for this reason it is difficult to transfer the idea to smaller-sized loads such as DC motors, for example in vehicles, with as little required installation space as possible.

In Ogasawara, S. & Akagi H.: “Circuit configurations and performance of the active common-noise canceler for reduction of common-mode voltage generated by voltage-source PWM inverters”, Okayama University (2000), published in “eScholarship@OUDIR: Okayama University Digital Information Repository”, web address: http://escholarship.lib.okayama-u.ac.jp/electrical Engineering/41, it is therefore proposed to supplement a setup with measurement of the common mode voltage and compensation in a transformer with an interposed high-pass filter. As a result, the transformer, for example, could have smaller dimensions.

But here too there are some disadvantages. There is a risk of the compensation becoming ineffective or even worsening, especially with fast edges and/or higher-order filters due to non-linearities or tolerances. As described, the filter can only react, but cannot already pre-magnetize the core in a different direction in each case before a steep edge, as it would be desirable.

A completely different approach is described in the document Turzynski, M. & Musznicki, P: A Review of Reduction Methods of Impact of Common-Mode Voltage on Electric Drives”, in Energies 14, 4003 (2021), (https://doi.org/10.3390/en14134003). A voltage signal corresponding to the interference variable is measured here on the drive lines—as seen from the signal generator—downstream of a compensation transformer. Therefore, it is not the actual common mode signal itself that is measured here, but rather the result of the transformer compensating it. In terms of circuitry, the voltage applied to a compensation winding in the transformer is regulated, for which a fault amplifier with a gain of >>1 is implemented.

The advantage is that the measured “interference signal” can be completely compensated by regulation to a DC voltage of 0 V. In addition, in this case, the system consisting of drive lines and load may remain dynamically oscillatable (within certain limits), in order to still allow the interference to be compensated by means of the regulation. On the other hand, the problem remains that the dimensions of the transformer are too large to be transferred, for example, to the control of DC or BLDC motors in vehicles.

The document CN 204030940 A shows a generally similar setup, but the regulation is used there to track a network reference.

There is therefore a need for a control device that allows common mode interference to be effectively compensated even with smaller dimensions of a corresponding compensation transformer.

### SUMMARY

Aspects of the invention relate to a control device for operating a load by means of pulse-width-modulated voltage signals via a cable harness comprising two or more drive lines. As described, such a cable harness can be subject to electromagnetic interference in the environment due to its length. The control device comprises a signal generator for generating and feeding the pulse-width-modulated voltage signals into a corresponding one of the drive lines, as well as a transformer (e.g. with a ferrite core etc.) with one winding each for each of the drive lines and with a compensation winding. The number of turns of the compensation winding can be selected differently than for the windings of the drive lines. Furthermore, this winding is not designed for the motor current, but may be much thinner. The winding directions preferably match.

A regulator circuit is configured to control a voltage applied to the compensation winding in order to reduce a possible common mode voltage. In particular, the regulator circuit is configured to capture the voltages of the respective voltage signals currently present on the drive lines between the transformer and the load and to determine an average value from these as a regulating variable for regulating the voltage applied to the compensation winding. This average value, measured “downstream of” the transformer, as seen from the signal processor, already represents a measure of the extent to which compensation in the transformer has affected an existing common mode voltage or interference.

Consequently, there is closed-loop regulation. It should be noted that overall, instead of the “average value”, it is also possible to refer to a “common mode voltage” in the actual sense.

In addition, a low-pass filter unit is now provided. This is configured to supply the regulator circuit for regulating the voltage applied to the compensation winding with a target or reference variable obtained from low-pass filtering of a signal which corresponds to a common mode voltage of the pulse-width-modulated voltage signals output by the signal generator onto the drive lines, or is provided by a microprocessor unit. The signal provided by the microprocessor unit can also, but need not, correspond to the respective current common mode voltage. The signal provided by the microprocessor unit may in particular be derived from a PWM signal (or dependent on it or calculated from it) which is output by the microprocessor unit to the signal generator in order to actually first generate the pulse-width-modulated voltage signals output onto the drive lines. Relevant embodiments are explained in more detail below.

The filtered signal or the reference variable is of low frequency and below a cutoff frequency which is immanent to the low-pass filter and can be selected in a suitable manner depending on the use of the control device.

This is based on the basic idea that a size of the transformer depends on the expected magnetization current to be supplied by one amplifier (or a plurality of amplifiers, see developments) and a related saturation of the transformer. These two factors are directly proportional to a temporal integral of the voltage applied to the compensation winding, or a corresponding voltage/time area.

In the case of the mere control described at the outset (no regulation), the temporal integral is fixed per se by the drive signals or their common mode extent. There is an influence at most from the described solution of a high-pass filter, by way of which treatment of low-frequency signal components in the drive signals can be excluded.

In the case of the regulation proposed here, however, use is made of the fact that the temporal integral can be influenced by a suitable selection of the reference variable. Especially when used, e.g., on loads such as conventional DC or BLDC motors in vehicles, it is usually not the fundamental wave and the first harmonic waves that lead to electromagnetic interference, but higher harmonics that fall into frequency ranges in which specified, more stringent limit values apply. For example, the usual PWM frequency of 20 kHz (e.g. the fundamental wave), or a medium wave range of 500 kHz to 2 MHz, etc., can be considered for this purpose. These values are examples only, and other environments can set limit values for other frequency ranges.

In contrast, however, it is precisely the lower frequencies that exert a particularly large influence on the temporal integral or the voltage/time area in the case of common mode interference. In this respect, it is a basic idea of the invention to dispense with regulation that also detects common mode interference at low frequencies during compensation.

This is achieved by dispensing with regulation to a predefined DC voltage, in particular 0 V, as the target or reference variable, and instead using a target or reference variable that omits low frequencies for the regulation. This target or reference variable is then usually fluctuating according to the low frequency or a superimposition or sum of the components of different low frequencies.

In other words, there is no longer regulation to DC voltage. As a result of the fact that according to the invention the reference variable itself can have low-frequency components, the temporal integral of the voltage applied to the compensation winding can now also be significantly reduced. As a result, it is also advantageously possible to have significantly smaller dimensions of the transformer serving the compensation when designing the control device. At the same time, the costs and effort needed to implement the control device, for example in a vehicle, in particular a motor vehicle, are also reduced.

This regulation to a target or reference variable, which may vary at low frequencies, is made possible by the low-pass filter unit which supplies the correspondingly filtered signal, which can correspond to the common mode interference before filtering, to the regulator circuit. The low-pass filter unit can receive a signal corresponding to the common mode voltage on the input side. The feature “correspond” should be broadly interpreted here. The common mode voltage can be amplified, inverted, shifted, etc. It is relevant for this alternative that the signal is obtained from the voltages of the respective voltage signals that are currently present on the drive lines between the signal generator and the transformer.

According to one development of the control device, the regulator circuit comprises a first amplifier, the inputs of which are supplied with the regulating variable or the reference variable, the output of which is connected, directly or via a capacitor, to one end of the compensation winding, and the gain of which is set via a resistor which is connected between the input, to which the regulating variable is supplied, and the output. This structure allows a relatively simple implementation of the regulator circuit.

A refinement of this development provides for the average value determined as the regulating variable to be obtained via a first voltage divider, wherein the corresponding input of the first amplifier is connected to a node which in turn is connected via respective resistors or capacitors to each of the drive lines between the transformer and the load. The voltage divider also allows a simple implementation of the regulator circuit.

Further embodiments provide an advantageous combination of simple control (with capture of the common mode voltage between the signal generator and the transformer) and regulation according to the invention (with capture of the already compensated common mode voltage between the transformer and the load). The special advantage arises from the fact that this variant can be implemented more easily and at lower costs, since the requirements for the amplifiers are greatly reduced.

For this purpose, an interference variable feedforward unit is provided and is configured to capture a common mode voltage currently applied to the drive lines between the signal generator and the transformer as an interference variable and to apply a voltage that counteracts the interference variable via the transformer to the compensation winding. In other words, the interference variable feedforward unit already ensures the magnitude of the compensation voltage, while the regulator circuit only has to carry out fine tuning, i.e., compensate the remaining residual deviations resulting from the described shortcomings of mere control.

As a result, however, the regulator circuit can also be designed in a much more conservative, robust and cheap manner.

Furthermore, the interference variable feedforward unit may have a second amplifier which is operated as an impedance converter and the non-inverting input of which is supplied with, as an interference variable, an average value of the voltages of the respective voltage signals that are currently present on the drive lines between the signal generator and the transformer. The output of the amplifier operated as an impedance converter is connected to the other end of the compensation winding.

In addition, the average value determined as an interference variable can be obtained via a second voltage divider, wherein the non-inverting input of the second amplifier operated as an impedance converter is connected to a second node which in turn is connected, via respective resistors or capacitors, to each of the drive lines between the signal generator and the transformer.

In these embodiments with a combination of (mere) control and regulation, the low-pass filter unit can now be advantageously connected on the input side to a third node at the output of the second amplifier operated as an impedance converter and can be connected on the output side to a corresponding input of the first amplifier of the regulator circuit in order to supply the captured, inverted and low-pass-filtered interference variable to the regulator circuit as a reference variable.

Thus, the interference variable inverted by the interference variable feedforward unit and provided at the third node cannot only be used for direct compensation via the compensation winding, but also for low-pass filtering for the provision of the reference variable in the regulator circuit.

A further aspect of the invention provides the microprocessor unit which has already been mentioned above and, according to the aspect, is connected to the signal generator via a first control output and controls the generation of the pulse-width-modulated voltage signals. The low-pass filter unit is connected on the input side to the microprocessor unit, wherein the microprocessor unit has a second control output and is configured to output a further pulse-width-modulated voltage signal to the low-pass filter unit via the second control output.

In this case, the further pulse-width-modulated voltage signal output to the low-pass filter unit via the second control output is generated depending on the pulse-width-modulated voltage signals generated via the first control output in the signal generator.

In particular, starting from the actual PWM signal at the first control output of the microprocessor unit, the duty ratio, phase and level of the (as yet unfiltered) target or reference variable can be adjusted here. The level can be much higher than the level of a signal at the output of the second amplifier, if a combination of (mere) control and regulation is also considered here (i.e. an implementation with the interference variable feedforward unit). The microprocessor unit here preferably generates square-wave signals at the same frequency as the actual drive or voltage signals which are output onto the drive lines.

However, the square-wave signal (i.e., the further pulse-width-modulated voltage signal at the second output of the microprocessor) differs from the voltage signals output onto the drive lines, as described, in terms of the duty ratio and the phase, specifically in such a way that the signal is optimized to a minimum voltage/time area, if it is used in filtered form as the reference variable during regulation. Setting the phase also makes it possible to achieve a desired pre-magnetization of the transformer, with the result that, with great advantage, the regulation no longer only reacts to the interference but can also be carried out proactively.

In addition, the microprocessor unit can also specify the signal level. This signal generated in this way is supplied to the regulator circuit via the low-pass filter unit.

This variant is comparatively simple to implement, since the microprocessor unit only needs to generate another PWM signal for the second control output, which means little effort.

According to a further embodiment, the microprocessor unit has a digital-to-analog converter at the second control output.

Provision may also be made for the low pass filter unit to comprise an RC element.

Overall, according to aspects, advantages are also achieved in that a common mode signal does not leave the control device at all, with the result that no compensation, filtering or shielding is required outside it. Furthermore, no basic adjustment of PWM signal generation is necessary. The half-bridge circuit, the output stages and the software remain unchanged, as do the connectors and the cable harness. In this respect, the invention is also conceivable in principle as a retrofit solution. Furthermore, the invention is not limited to conventional brush-operated DC or brushless BLDC motors, but is also applicable to PWM-operated relays, etc., as described at the outset.

Further advantages, features and details of the various aspects emerge from the claims, the following description of preferred embodiments as well as from the drawings. In the figures, the same reference signs denote the same features and functions.

### BRIEF DESCRIPTION OF THE DRAWINGS

In the drawings:

FIG. 1 shows a schematic circuit diagram of a control device according to one exemplary embodiment of the present invention with two embodiment variants shown therein for the arrangement of the low-pass filter unit;

FIG. 2 shows a schematic diagram of the temporal profile of the voltage levels at the nodes N3 (solid line) and N4 (dash-dotted line) at the outputs of the amplifiers in the control device from FIG. 1, as well as of the voltage applied to the compensation winding (dashed line) and the temporal integral of the same (dotted line), for the conventional case without filtering;

FIG. 3 shows the same illustration as in FIG. 2, but for the case of filtering via the first low-pass filter unit shown in FIG. 1;

FIG. 4 shows the same illustration as in FIG. 1, but for the case of filtering via the second low-pass filter unit shown in FIG. 1.

### DETAILED DESCRIPTION

In the following description of a preferred exemplary embodiment, it should be taken into consideration that the present disclosure of the various aspects is not limited to the details of the structure and the arrangement of the components illustrated in the following description and in the figures. All exemplary embodiments, even those not shown in the figures, can be put into practice or executed in various ways.

It should also be taken into consideration that the wording and terminology used here is used merely for the purpose of the specific description and should not be interpreted restrictively as such by a person skilled in the art. In addition, in the following description, the same reference signs in the figures denote the same or similar features or objects, and therefore in some cases a repeated detailed description of them is omitted in order to maintain the compactness and clarity of the illustration.

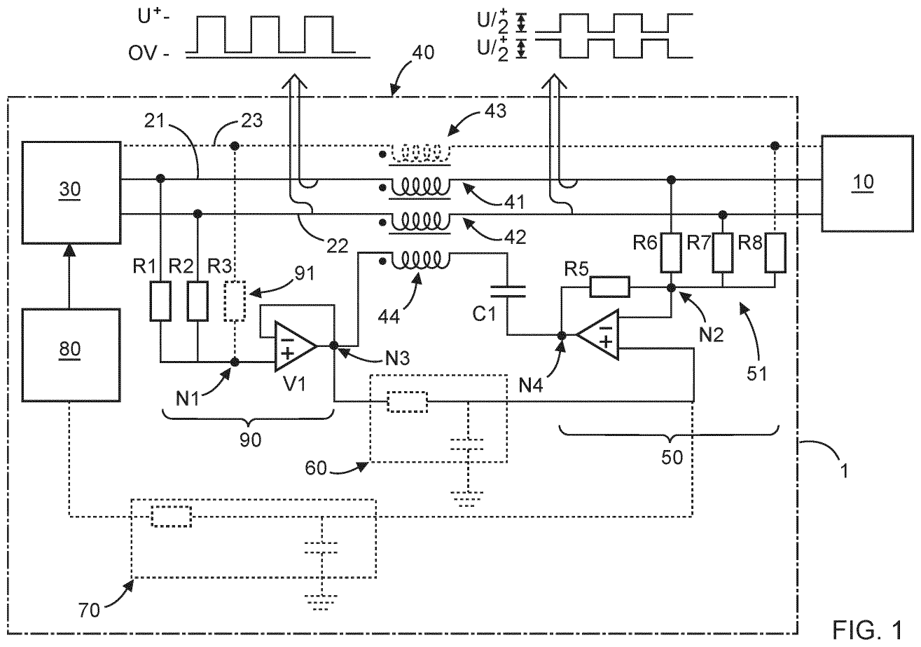

FIG. 1 shows a schematic circuit diagram of a control device 1 for operating a load 10 according to one exemplary embodiment with 2 variants indicated therein. The control device 1 comprises a microprocessor unit 80 which controls the generation of pulse-width-modulated voltage signals in a signal generator 30 via a first control output. The signal generator 30 may have in a known manner half bridges (from corresponding bipolar transistors or the like) which are not shown here and have a power supply and an output stage. The microprocessor unit 80 drives the corresponding base connections or gates of the transistors in order to generate pulse-width-modulated voltage signals with a predetermined duty ratio in a desired manner by means of corresponding switching processes.

These voltage signals are output onto drive lines 21, 22 and 23 which are connected to the load 10 at their opposite end.

In the present exemplary embodiment, the load 10 may be a conventional, brush-operated DC motor or a brushless DC motor (BLDC) designed, for example, to drive a movable component in a vehicle, e.g. a sunroof, a sliding door or a movable window. Two drive lines 21, 22 are provided in the case of the brush-operated DC motor and three drive lines 21, 22, 23 are provided in the case of the brushless DC motor (BLDC) in order to enable electronic commutation. The third drive line is accordingly illustrated with a dashed line. The duty ratio of the pulse-width-modulated voltage signals is used to control the speed of the DC motor.

The control device 1 further comprises a transformer 40. Corresponding sections of the respective drive lines 21, 22, 23 are wound in a suitable manner around a suitably configured ferrite core. The number of turns is the same. The same applies to the winding direction. A voltage can be induced on the respective drive lines 21, 22, 23 in a desired manner via the corresponding windings 41, 42, 43 in order to adjust the signal levels.

A further compensation winding 44, at the ends of which a voltage can be applied, is used for this purpose. In particular, the compensation winding 44 is used to compensate for common mode interference occurring on the drive lines 21, 22, 23. The common mode interference is illustrated schematically in FIG. 1 for the two drive lines 21, 22 in the upper region of FIG. 1. In the present case, the pulse-width-modulated voltage signals are intended to be adapted by applying a voltage to the compensation winding 44 in such a way that the common mode interference is reduced. This is shown schematically in FIG. 1 above at the top right, wherein the voltage levels of the two signals are adapted such that they cancel each other out.

For this purpose, the control device 1 has an interference variable feedforward unit 90. The interference variable feedforward unit 90 first comprises a (second) voltage divider 91, wherein a (second) node N1 is coupled to one of the drive lines 21, 22, 23 in each case via preferably identical resistors R1, R2, R3. Therefore, due to the property of the second voltage divider 91, an average value of the voltage signals currently running via the drive lines 21, 22, 23 at the coupling points is obtained at the node N1. The average value represents a measure of the common mode interference currently present between the signal generator 30 and the transformer 40.

The second node N1 is connected to a non-inverting input of a (second) amplifier V1. In other words, the interference variable corresponding to the common mode interference is present at the non-inverting input of the second amplifier V1.

Its output is fed back to the inverting input of the second amplifier V1 via a third node N3. The amplifier V1 is therefore operated as an impedance converter which is regarded here as part of the interference variable feedforward unit 90. The third node N3 is also connected to one end of the compensation winding 44. As a result, the voltage of the inverted interference variable is applied to the compensation winding 44. In the transformer 40, this induces a voltage that counteracts the interference variable on the respective drive lines 21, 22 and 23.

As described at the outset, however, residual voltages that are not compensated remain on the drive lines 21, 22 and 23 for various reasons. In order to deal with this, the control device 1 further comprises a regulator circuit 50, as can be seen in FIG. 1. Like the interference variable feedforward unit 90, the regulator circuit 50 has a (first) voltage divider 51, in which a first node N2 is connected via in each case identical resistors R6, R7 and R8 to the respective drive lines 21, 22, 23 in a section between the transformer 40 and the load 10. Like in the case of the second node N1, an average value of the voltage levels of the corresponding voltage signals currently present on the drive lines 21, 22, 23 is also present at the first node N2 as a result of the first voltage divider 51—here, however, in the section between the transformer 40 and the load 10 “downstream of” the transformer, in which the voltage levels of the pulse-width-modulated voltage signals have already been adjusted by the voltage applied to the compensation winding 40.

The first node N2 is further connected to the inverting input of a first amplifier V2, to which that average value is thus supplied as a regulating variable for the regulation. The output of the first amplifier is also connected to the inverting input via a resistor R5, with the result that a gain (gain >>1) can be set via the resistor R5. The output of the first amplifier V2 is connected to the other end of the compensation winding 44 via a capacitor C1.

The capacitor C1 is used for DC decoupling.

Overall, this design can be used to implement a control loop, by means of which a suitable target or reference variable applied to the non-inverting input of the first amplifier V2 is used to regulate a common mode voltage on the drive lines in the section between the transformer 40 and the load 10 to precisely that target value via the compensation winding 44.

As can be seen in the lower part of FIG. 1, the first amplifier V2 of the regulator circuit 50 is supplied, at its non-inverting input, via a low-pass filter unit 60 comprising an RC element, with the inverted interference variable present at the second node N1 in low-pass filtered form as a target value or reference variable for the regulation. As a result, the common mode voltage on the drive lines is no longer regulated to a constant DC voltage or 0 V, but to a voltage level varying at low frequencies. However, high-frequency common mode interference is still regulated as desired. The low-frequency common mode interference is not regulated, however, but hardly causes interference in particular in the case of the described application (e.g. in motor vehicles), because the relevant medium-wave range is not affected in particular. The corresponding cutoff frequency can be set by suitably selecting the resistor and the capacitor in the low-pass filter.

FIG. 1 also shows an alternative to the first low-pass filter unit 60. The low-pass filter unit 70 is connected on the input side to a second control connection 82 of the microprocessor unit 80. Like the first low-pass filter unit 60, the second low-pass filter unit 70 has an RC element as a low-pass filter. Furthermore, it is also connected on the output side to the non-inverting input of the first amplifier V2 in order to supply it with a low-pass filtered signal as a reference variable. The voltage signal supplied to the second low-pass filter unit 70 by the microprocessor unit 80 may be, in this variant, for example, a pulse-width-modulated voltage signal (DC motor, in the case of a BLDC motor, this signal may be more complex) which is dependent on the pulse-width-modulated voltage signal generated via the first control output and output by the signal generator 30 (in the case of the BLDC motor, the signal is dependent on the 3 PWM signals in each case).

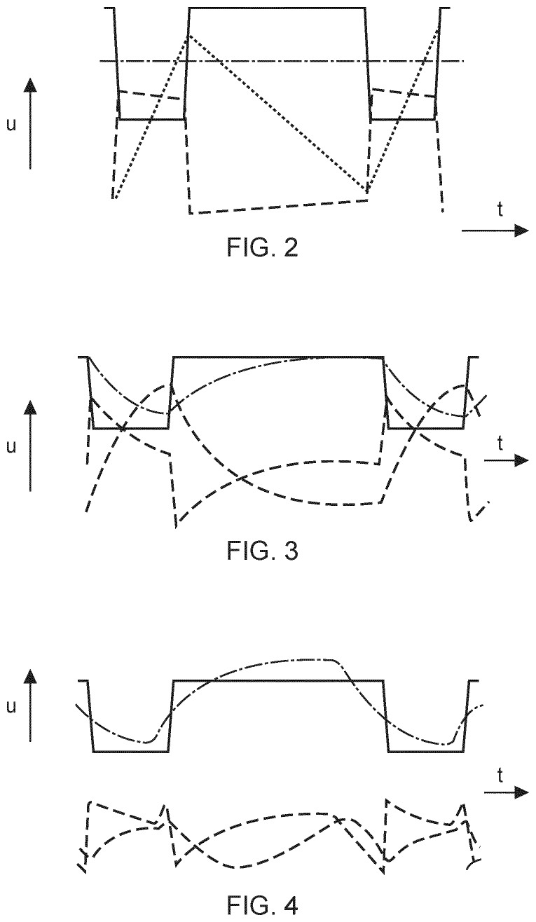

In particular, it is a square-wave signal at the same frequency, which may differ, however, from the actual PWM signal for the drive lines in terms of duty ratio, phase and signal level. Here, aspects represent an optimization to a minimum voltage/time area, as shall be shown below with reference to FIGS. 2-4.

FIGS. 2 to 4 show a temporal profile of the voltage levels applied to the third node N3 and to a fourth node N4 (solid curve for N3 and dash-dotted curve for N4) as well as the corresponding voltage applied to the compensation winding 44 (dashed curve). The dotted curve shows the profile of the temporal integral of the voltage applied to the compensation winding 44. The corresponding voltage/time area represents a measure of the required dimensions of the transformer which should to be kept as small as possible according to aspects of the invention.

FIG. 2 first of all shows the temporal profile for the variant from FIG. 1 with the first low-pass filter unit 60, but for demonstration purposes the low-pass filtering is switched off here (no RC element, no cutoff frequency or infinite cutoff frequency).

A pronounced sawtooth curve is clearly visible for the temporal integral.

In comparison with this, FIG. 3 shows a case for the same variant in which the low-pass filtering is switched on. Compared to the temporal integral of the voltage from FIG. 2, in this case in FIG. 3, the voltage/time area is almost halved (56% peak to peak), and so advantages already clearly arise with regard to reducing the required transformer size.

FIG. 4 shows the temporal profile using the second low-pass filter unit 70. Here, the voltage signal to be filtered is generated by the microprocessor unit 80, as described. In particular, the phase of the voltage signal to be filtered is adapted by the microprocessor unit 80 in comparison with the PWM voltage signal output on the drive lines or the pulse edges are slightly brought forward in time in order to generate a pre-magnetization, as can be seen from the corresponding solid curve for the third node N3.

However, this gives the voltage applied to the compensation winding (dashed curve) a form such that its temporal integral or voltage/time area is even smaller than in the case in FIG. 3, namely only a quarter (25% peak-to-peak).

### LIST OF REFERENCE SIGNS

1 Control device
10 Load
20 Cable harness
21 Drive line
22 Drive line
23 Drive line
30 Signal generator
40 Transformer
41 Winding
42 Winding
43 Winding
44 Compensation winding
50 Regulator circuit
51 First voltage divider
60 Low-pass filter unit
70 Low-pass filter unit
80 Microprocessor unit
81 First control output
82 Second control output
90 Interference variable feedforward unit
91 Second voltage divider
C1 Capacitor
N1 Second node
N2 First node
N3 Third node
N4 Fourth node
R5 Resistor
R6 Resistor
R7 Resistor
R8 Resistor
V1 Second amplifier
V2 First amplifier

1: A control device for operating a load by means of pulse-width-modulated voltage signals via a cable harness comprising two or more drive lines, comprising:
a signal generator which is configured to generate and feed the pulse-width-modulated voltage signals into a corresponding one of the drive lines;
a transformer with one winding each for each of the drive lines and with a compensation winding;
a regulator circuit which is configured to regulate a voltage applied to the compensation winding in order to reduce a possible common mode voltage on the drive lines;
wherein the regulator circuit is configured to capture the voltages of the respective voltage signals currently present on the drive lines between the transformer and the load and to determine an average value from these as a regulating variable for regulating the voltage applied to the compensation winding,
a low-pass filter unit which is configured to supply the regulator circuit for regulating the voltage applied to the compensation winding with a reference variable obtained from low-pass filtering of a signal, which at least one of:
corresponds to a common mode voltage of the pulse-width-modulated voltage signals output by the signal generator onto the drive lines, and
is provided by a microprocessor unit.

2: The control device as claimed in claim 1, wherein the regulator circuit comprises a first amplifier, the inputs of which are supplied with at least one of: the regulating variable and the reference variable, the output of which is connected, at least one of: directly and via a capacitor, to one end of the compensation winding, and the gain of which is set via a resistor which is connected between the input, to which the regulating variable is supplied, and the output.

3: The control device as claimed in claim 2, wherein the average value determined as the regulating variable is obtained via a first voltage divider, wherein the corresponding input of the first amplifier is connected to a node which in turn is connected via respective at least one of: resistors and capacitors to each of the drive lines between the transformer and the load.

4: The control device as claimed in claim 2, further comprising:
an interference variable feedforward unit which is configured to capture a common mode voltage currently present on the drive lines between the signal generator and the transformer as an interference variable and apply a voltage that counteracts the interference variable via the transformer to the compensation winding.

5: The control device as claimed in claim 4, wherein the interference variable feedforward unit has a second amplifier which is operated as an impedance converter and the non-inverting input of which is supplied with, as an interference variable, an average value of the voltages of the respective voltage signals that are currently present on the drive lines between the signal generator and the transformer; wherein the output of the amplifier operated as an impedance converter is connected to the other end of the compensation winding.

6: The control device as claimed in claim 5, wherein the average value determined as an interference variable is obtained via a second voltage divider, wherein the non-inverting input of the second amplifier operated as an impedance converter is connected to a second node which in turn is connected, via respective at least one of: resistors and capacitors, to each of the drive lines between the signal generator and the transformer.

7: The control device as claimed in claim 5, wherein the low-pass filter unit is connected on the input side to a third node at the output of the second amplifier operated as an impedance converter and is connected on the output side to a corresponding input of the first amplifier of the regulator circuit in order to supply the captured, inverted and low-pass-filtered interference variable to the regulator circuit as the reference variable.

8: The control device as claimed in claim 1, further comprising:
the microprocessor unit which is connected to the signal generator via a first control output and controls the generation of pulse-width-modulated voltage signals;
wherein the low-pass filter unit is connected on the input side to the microprocessor unit;
wherein the microprocessor unit has a second control output and is configured to output a further pulse-width-modulated voltage signal to the low-pass filter unit via the second control output; and
wherein the further pulse-width-modulated voltage signal output via the second control output is generated depending on the pulse-width-modulated voltage signals generated via the first control output in the signal generator.

9: The control device as claimed in claim 8, wherein the microprocessor unit has a digital-to-analog converter at the second control output.

10: The control device as claimed in claim 1, wherein the low-pass filter unit comprises an RC element.
